(19) United States
(12) Patent Application Publication
(10) Pub. No.: US 2024/0259873 A1
(43) Pub. Date: Aug. 1, 2024

(54) INTENT BASED OPTIMIZATION OF RAN AND O-CLOUD RESOURCES IN SMO O-RAN FRAMEWORK

(71) Applicant: RAKUTEN MOBILE, INC., Tokyo (JP)

(72) Inventors: Pankaj SHETE, Tokyo (JP); Awn MUHAMMAD, Tokyo (JP)

(73) Assignee: RAKUTEN MOBILE, INC., Tokyo (JP)

(21) Appl. No.: 18/018,403

(22) PCT Filed: Dec. 27, 2022
(86) PCT No.: PCT/US2022/054055

§ 371 Date: Jan. 27, 2023

(51) Int. Cl. H04W 28/08; H04W 28/18

(52) U.S. Cl. CPC H04W 28/0925; H04W 28/18

(57) ABSTRACT

A method of generating policies/configurations in an open radio access network (O-RAN) service management and orchestration (SMO) framework, the SMO framework including an intent interface termination and a non-real-time RAN intelligent controller (NRT RIC), may include obtaining an input corresponding to an intent policy for at least one operation of the SMO framework, determining the intent policy of the input, generating an SMO policy/configuration based on the intent policy, and implementing the SMO policy/configuration on at least one of a near-real-time RIC (nRT RIC), at least one RAN node, and an O-RAN Cloud (O-Cloud).

### 1. FIELD

Apparatuses and methods consistent with example embodiments of the present disclosure relate to policy/configuration implementation in an open radio access network (O-RAN) Service Management and Orchestration (SMO) framework.

### 2. DESCRIPTION OF RELATED ART

A radio access network (RAN) is an important component in a telecommunications system, as it connects end-user devices (or user equipment) to other parts of the network. The RAN includes a combination of various network elements (NEs) that connect the end-user devices to a core network. Traditionally, hardware and/or software of a particular RAN is vendor specific.

Open RAN (O-RAN) technology has emerged to enable multiple vendors to provide hardware and/or software to a telecommunications system. To this end, O-RAN disaggregates the RAN functions into a centralized unit (CU), a distributed unit (DU), and a radio unit (RU). The CU is a logical node for hosting Radio Resource Control (RRC), Service Data Adaptation Protocol (SDAP), and/or Packet Data Convergence Protocol (PDCP) sublayers of the RAN. The DU is a logical node hosting Radio Link Control (RLC), Media Access Control (MAC), and Physical (PHY) sublayers of the RAN. The RU is a physical node that converts radio signals from antennas to digital signals that can be transmitted over the FrontHaul to a DU. Because these entities have open protocols and interfaces between them, they can be developed by different vendors.

FIG. 1 is a diagram of a related art O-RAN architecture, FIG. 2 is a diagram of a related art Service Management and Orchestration (SMO) framework with a non-real-time (NRT) RAN Intelligent Controller (RIC) architecture in a functional view, and FIG. 3 is a diagram of a related art SMO framework with an NRT RIC in a services view. Referring to FIGS. 1 through 3, RAN functions in the O-RAN architecture are controlled and optimized by a RIC. The RIC is a software-defined component that implements modular applications to facilitate the multivendor operability required in the O-RAN system, as well as to automate and optimize RAN operations. The RIC is divided into two types: an NRT RIC and a near-real-time RIC (nRT RIC).

The NRT RIC is the control point of a non-real-time control loop and operates on a timescale greater than 1 second within the SMO framework. Its functionalities are implemented through modular applications called rApps (rApp 1, . . . , rApp N in FIGS. 1-3), and include: providing policy based guidance and enrichment across the A1 interface, which is the interface that enables communication between the NRT RIC and the nRT RIC; performing data analytics; Artificial Intelligence/Machine Learning (AI/ML) training and inference for RAN optimization; and/or recommending configuration management actions over the O1 interface, which is the interface that connects the SMO to RAN managed elements (e.g., nRT RIC, O-RAN Centralized Unit (O-CU), O-RAN Distributed Unit (O-DU), etc.).

The nRT RIC operates on a timescale between 10 milliseconds and 1 second and connects to the O-DU, O-CU (disaggregated into the O-CU control plane (O-CU-CP) and the O-CU user plane (O-CU-UP)), and an open evolved NodeB (O-eNB) via the E2 interface. The nRT RIC uses the E2 interface to control the underlying RAN elements (E2 nodes/network functions (NFs)) over a near-real-time control loop. The nRT RIC monitors, suspends/stops, overrides, and controls the E2 nodes (O-CU, O-DU, and O-eNB) via policies. For example, the nRT sets policy parameters on activated functions of the E2 nodes. Further, the nRT RIC hosts xApps to implement functions such as quality of service (QOS) optimization, mobility optimization, slicing optimization, interference mitigation, load balancing, security, etc. The two types of RICs work together to optimize the O-RAN. For example, the NRT RIC provides, over the A1 interface, the policies, data, and artificial intelligence (AI)/machine learning (ML) models enforced and used by the nRT RIC for RAN optimization, and the nRT returns policy feedback (i.e., how the policy set by the NRT RIC works).

The SMO framework, within which the NRT RIC is located, manages and orchestrates RAN elements. Specifically, the SMO manages and orchestrates what is referred to as the O-RAN Cloud (O-Cloud). The O-Cloud is a collection of physical RAN nodes that host the RICs, O-CUs, and O-DUs, the supporting software components (e.g., the operating systems and runtime environments), and the SMO itself. In other words, the SMO manages the O-Cloud from within. The O2 interface is the interface between the SMO and the O-Cloud it resides in. Through the O2 interface, the SMO provides infrastructure management services (IMS) and deployment management services (DMS).

In related art, O-RAN frameworks allow different users to input policies in a form that only a particular constituency of users understand. For example, business users (e.g., users with only a high level understanding of the system operations) may only be capable of writing intent policies using business terms and not system level terms/commands, such as scripting language like JSON, xml, etc. There are currently no specified procedures for optimizing RAN or O-Cloud resources based on internally or externally defined intents.

### SUMMARY

According to embodiments, systems and methods are provided that enable different users of an open radio access network (O-RAN) to input intent policies.

According to an aspect of the disclosure, a method of generating policies/configurations in an O-RAN service management and orchestration (SMO) framework, the SMO framework including an intent interface termination and a non-real-time RAN intelligent controller (NRT RIC), may include obtaining an input corresponding to an intent policy for at least one operation of the SMO framework, determining the intent policy of the input, generating an SMO policy/configuration based on the intent policy, and implementing the SMO policy/configuration on at least one of a near-real-time RIC (nRT RIC), at least one RAN node, and an O-RAN Cloud (O-Cloud).

According to an aspect of the disclosure, a system for generating policies/configurations in an O-RAN SMO framework, the SMO framework comprising an intent interface termination and a NRT RIC, may include at least one memory storing instructions and at least one processor configured to execute the instructions to obtain an input corresponding to an intent policy for at least one operation of the SMO framework, determine the intent policy of the input, generate an SMO policy/configuration based on the intent policy, and implement the SMO policy/configuration on at least one of a nRT RIC, at least one RAN node, and an O-Cloud.

According to an aspect of the disclosure, a non-transitory computer-readable storage medium may store instructions that, when executed by at least one processor in an O-RAN SMO framework, cause the at least one processor to obtain an input corresponding to an intent policy for at least one operation of the SMO framework, determine the intent policy of the input, generate an SMO policy/configuration based on the intent policy, and implement the SMO policy/configuration on at least one of a nRT RIC, at least one RAN node, and an O-Cloud.

Additional aspects will be set forth in part in the description that follows and, in part, will be apparent from the description, or may be realized by practice of the presented embodiments of the disclosure.

### BRIEF DESCRIPTION OF THE DRAWINGS

Features, advantages, and significance of exemplary embodiments of the disclosure will be described below with reference to the accompanying drawings, in which like signs denote like elements, and wherein:

FIG. 1 is a diagram of a related art open radio access network (O-RAN) architecture;

FIG. 2 is a diagram of a related art Service Management and Orchestration (SMO) framework with a non-real-time (NRT) RAN Intelligent Controller (RIC) architecture in a functional view;

FIG. 3 is a diagram of a related art SMO framework with an NRT RIC in a services view;

FIG. 4 is a diagram of a relationship between rules, policies and intents, according to an embodiment;

FIGS. 5-9 are diagrams of O-RAN frameworks, according to embodiments;

FIG. 10 is a flowchart of a method of generating policies/configurations in an O-RAN SMO framework;

FIG. 11 is a diagram of an example environment in which systems and/or methods, described herein, may be implemented; and

FIG. 12 is a diagram of example components of a device according to an embodiment.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Example embodiments of the present disclosure provide a system in an open radio access network (O-RAN) service management and orchestration (SMO) framework, the SMO framework including an intent interface termination and a non-real-time RAN intelligent controller (NRT RIC), where the system may obtain an input corresponding to an intent policy for at least one operation of the SMO framework, determine the intent policy of the input, generate an SMO policy/configuration based on the intent policy, and implement the SMO policy/configuration on at least one of a near-real-time RIC (nRT RIC), at least one RAN node, and an O-RAN Cloud (O-Cloud). The system may determine an abstraction level of the intent policy, where the abstraction level includes one of a business abstraction level and a system abstraction level. The system may, based on determining the abstraction level of the intent policy as the business abstraction level, translate the intent policy to correspond to at least one system level command.

The system may obtain the input and determine the intent policy by the intent interface termination, and generate the SMO policy/configuration by the NRT RIC. The system may obtain the input by the intent interface termination, and determine the intent policy and generate the SMO policy/configuration by the NRT RIC. The NRT RIC may include an rApp on which a policy management function module is deployed, and the system may obtain the input by the intent interface termination, and determine the intent policy and generate the SMO policy/configuration by the policy management function module that is deployed on the rApp. The NRT RIC may include an rApp and a policy management function module deployed outside of the rApp, and the system may obtain the input by the intent interface termination, and determine the intent policy and generate the SMO policy/configuration by the policy management function module that is not deployed on the rApp.

The systems, methods, devices, etc., disclosed herein allow intent policies to be input from various users of varying types of language, such that SMO policies/configurations may be implemented based on the varying intent policies.

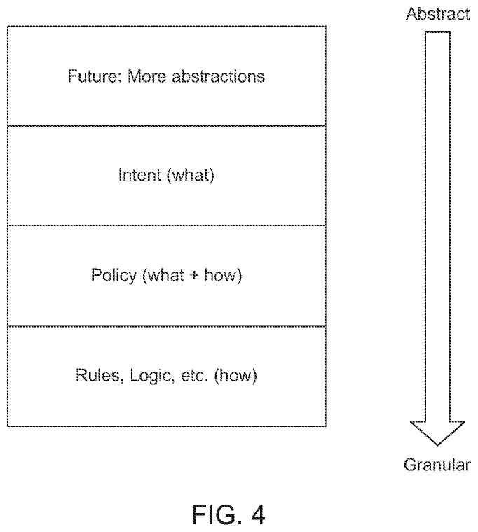

FIG. 4 is a diagram of a relationship between rules, policies and intents, according to an embodiment. In reference to FIG. 4, an intent may specify the expectations of an O-RAN, including requirements, goals, and constraints for a specific service or network management workflow, a policy may specify the action(s) to be taken when given condition occurs, and a rule may specify the explicit formula logics to be executed. For certain scenarios, policies may be used in conjunction with intents to achieve autonomous purposes. The systems and methods provided herein shift network functionality focus from a rule-based management system (e.g., management based on relationship between policies and rules (i.e., the “how” aspects of FIG. 4)) to a policy driven management system (e.g., management based on a relationship between intents and policies (i.e., the “what” aspects of FIG. 4)). That is, an intent driven system may be able to learn the behavior of networks and services and allow a customer to provide the desired state, without detailed knowledge of how to get to the desired state. For example, a user may input a particular parameter or property as an input intent policy (e.g., maintain coverage in a particular area, prevent handovers from occurring within a given area, maintain specific quality over a period of time, etc.) as non-system level commands, and the system may be configured to generate an SMO policy/configuration based on the input intent policy.

As referred to herein, “intent” and “intent policy” may be used interchangeably to refer to at least one intended policy/result that is input in the O-RAN system.

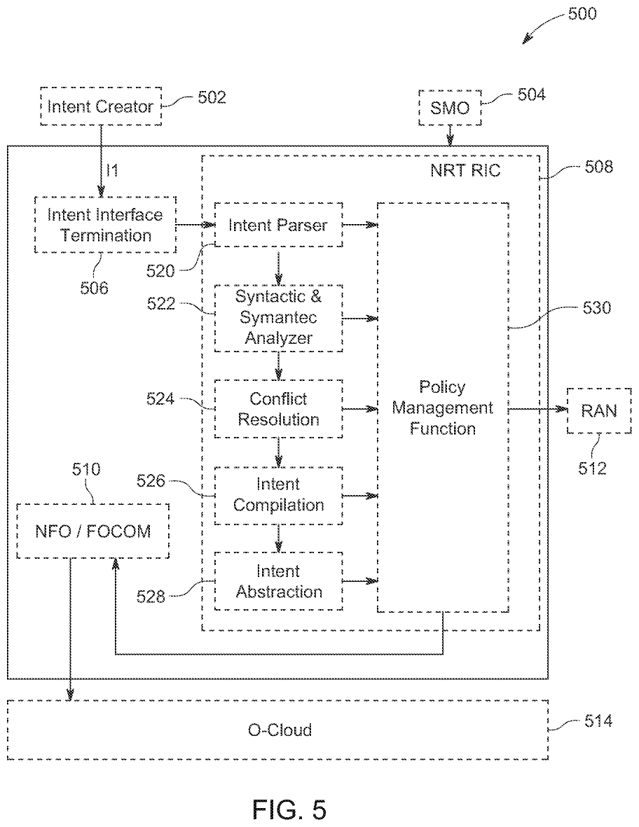

FIG. 5 is a diagram of an O-RAN framework 500, according to an embodiment. The O-RAN framework 500 may include an intent creator 502 (e.g., a user, a user terminal, etc.), an SMO framework 504, and intent interface termination 506 in communication with the intent creator 502 via an I1 interface, an NRT RIC 508, a network function orchestration (NFO)/federated O-Cloud Orchestration and Management (FOCOM) module 510, and RAN node 512 and an O-Cloud 514 (e.g., an infrastructure management service (IMS), a deployment management service (DMS), etc.).

The input creator 502 may include a set of authorized entities including the user, the application (e.g., an rApp), an operations support system (OSS), a business support system (BSS), orchestrator external entities, etc. that may create an intent policy. The intent creator 502 may submit the intent policy to the SMO framework 504 through a dedicated external reference point terminated at the SMO framework 504 (e.g., intent interface termination 506).

The intent interface termination 506 may terminate the intent interface in the SMO framework 504. The intent interface termination 506 may expose details of application programming interfaces (APIs) for intent determination and translation available in the NRT RIC 508. The intent interface termination 506 may receive an intent policy from intent creator 502 and the convert/forward the intent policy to the NRT RIC 508.

The NRT RIC 508 may include an intent parser 520, a syntactic and semantic analyzer 522, a conflict resolution module 524, an intent compilation module 526, an intent abstraction module 528, and a policy management function module 530.

The intent parser 520 may be is responsible for the initial parsing of the obtained intent policy. The intent parser 520 may perform lexical analysis, token generation, and syntactic analysis, etc., In the event of an error occurring during the parsing process, appropriate error messages may be sent to the intent creator 502, and the SMO framework 504 may record the errors for further analysis.

The syntactic and semantic analyzer 522 may provide meaning to the output of the intent parser 520. Examples include datatype checking, array bounds checking, proper declaration of variables, scope resolution, etc. The syntactic and semantic analyzer 522 may generate gist and keywords to provide additional knowledge to other functional blocks. In the event of an error occurring during this process, error messages may be sent to the intent creator 502.

The conflict resolution module 524 may check if the current intent policy conflicts with any existing policies. Upon detection of a conflict, the conflict resolution module 524 may inform the intent creator 502 of the conflict, while also providing details of the policy conflict.

The intent compilation module 526 may be configured to compile the intent in a format that is understood by the O-RAN architecture 500.

The intent abstraction module 528 may identify the abstraction level of the input intent policy. The intent abstraction module 528 may define the target output abstraction level, as well as the types of output configuration parameters, based on the semantics of the intent policy, the gist and keywords, and the input abstraction level. For instance, an end user may input an intent policy to improve video streaming quality without supplying any technical details, and the intent abstraction module 528 may be configured to identify the abstraction level of the input intent policy as a business abstraction level. As another example, an end user may input an intent policy to improve video streaming quality while supplying any technical details, and the intent abstraction module 528 may be configured to identify the abstraction level of the input intent policy as a system abstraction level. The intent abstraction module 528 may be configured to determine whether one or more translations are required between the input and output abstraction levels. Once the current abstraction level has successfully completed, the intent abstraction module 528 may determine whether another abstraction level translation is required, or whether the process is complete. When another abstraction level translation is required, the intent abstraction module 528 may return control to the intent parser 520 with new instructions. When no further abstraction level translations are required, the completed Intent Policy may be sent to the intent compilation module 526.

The policy management function module 530 may manage the compiled intent policy to generate policies or configurations for a near-RT RIC (nRT RIC), RAN nodes (e.g., RAN node 512), and/or the O-Cloud (e.g., O-Cloud 514). The policy management function module 530 may verify, validate, and authorize policies/configurations. The policy management function module 530 may create polices/configurations for the nRT RIC based on the received intent. Based on an abstraction level, the policy management function module 530 may determine to create policies or direct configurations for RAN nodes (e.g., RAN node 512), and/or the O-Cloud (e.g., O-Cloud 514). For example, when a throughput requirement for video streaming is provided in the intent policy, the intent policy may be determined to be of a system abstraction level, where the policy management function module 530 may directly provide configurations to RAN Nodes. Alternatively, when the intent policy only mentions basic or general video quality streaming parameters, such as 480p, 1080p, etc., the intent policy may be determined to be of a business abstraction level, which may require a looped policy to maintain desired video quality. Thus, the policy management function module 530 may determine key performance indicators (KPIs) to monitor to implement the intent policy. That is, if the intent policy is provided on low, engineering level (e.g., system level commands or parameters), and the policy management function module 530 may generate a policy/configuration for the intent policy and implement the generated policy/configuration without intent abstraction.

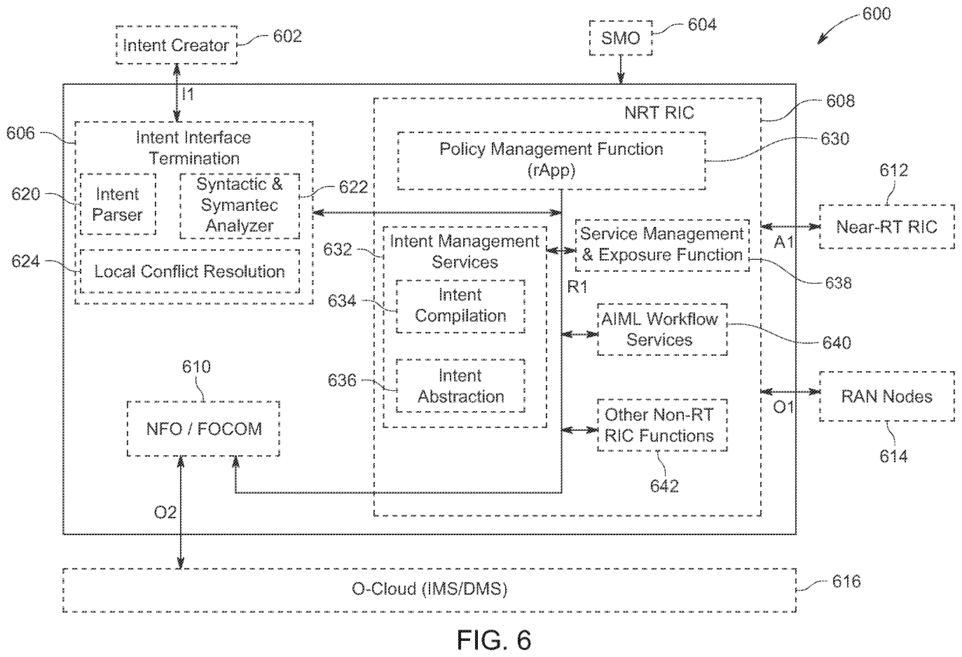

FIGS. 6-9 show various deployment configurations for implementing intent policy processing. FIGS. 6-9 include components similar to those already described with respect to FIG. 5, and repeated descriptions will be omitted.

FIG. 6 is a diagram of an O-RAN framework 600, according to an embodiment. The O-RAN framework 600 may include an intent creator 602, an SMO framework 604, and intent interface termination 606 in communication with the intent creator 602 via an I1 interface, an NRT RIC 608, a NFO/FOCOM module 610, and an nRT RIC 612, RAN nodes 614 and an O-Cloud 616 (e.g., an IMS, a DMS, etc.). The intent interface termination 606 may include an intent parser 620, a syntactic and semantic analyzer 622, and a local conflicts resolution module 624. The NRT RIC 608 may include an rApp on which a policy management function module 630 is deployed, an intent management services configuration 632 including an intent compilation module 634 and an intent abstraction module 636, a service management and exposure function module 638, an artificial intelligence/machine learning (AIML) workflow services module 640, and other NRT RIC functions 642. The policy management function module 630 may be in communication with the NFO/FOCOM module 610 via an R1 interface, the NFO/FOCOM module 610 may be in communication with the O-Cloud 616 via an O2 interface, the NRT RIC 608 may be in communication with the nRT RIC 612 via an A1 interface, and the NRT RIC 608 may be in communication with the RAN nodes 614 via an O1 interface.

As shown in FIG. 6, the intent interface termination 606 includes the intent parser 620, the syntactic and semantic analyzer 622, and the local conflicts resolution module 624, as opposed to FIG. 5 where such components were deployed on the NRT RIC. Dividing the framework as such may be determined based on a relevant function required to remain with the SMO 604 while communicating with the intent creator 602 without involvement of the NRT RIC 608. In the event of errors or conflicts with input intent policies, the framework 600 may be able to respond to such events without using resources of the NRT RIC 608. As initial functionalities of the intent framework typically demand frequent communication with the intent creator 602 to derive the meaning of the intent, the framework 600 may reduce the load on the R1 interface since initial functionalities of the intent framework are deployed outside of the NRT RIC 608.

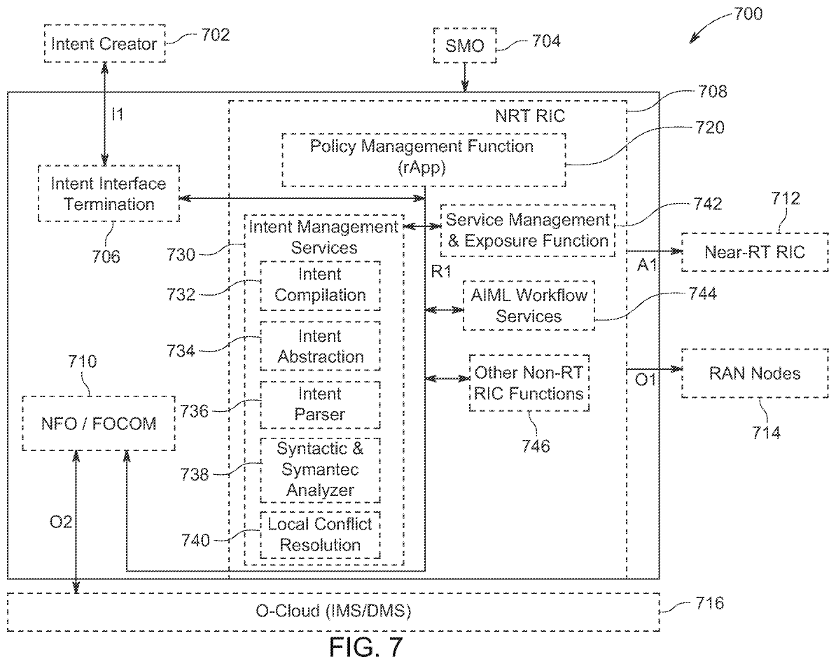

FIG. 7 is a diagram of an O-RAN framework 700, according to an embodiment. The O-RAN framework 700 may include an intent creator 702, an SMO framework 704, and intent interface termination 706 in communication with the intent creator 702 via an I1 interface, an NRT RIC 708, a NFO/FOCOM module 710, and an nRT RIC 712, RAN nodes 714 and an O-Cloud 716 (e.g., an IMS, a DMS, etc.). The NRT RIC 708 may include an rApp on which a policy management function module 720 is deployed, an intent management services configuration 730 including an intent compilation module 732, an intent abstraction module 734, an intent parser 736, a syntactic and semantic analyzer 738 and a local conflict resolution module 740. The NRT RIC 708 may include a service management and exposure function module 742, an AIML workflow services module 744, and other NRT RIC functions 746. The policy management function module 720 may be in communication with the NFO/FOCOM module 710 via an R1 interface, the NFO/FOCOM module 710 may be in communication with the O-Cloud 716 via an O2 interface, the NRT RIC 708 may be in communication with the nRT RIC 712 via an A1 interface, and the NRT RIC 708 may be in communication with the RAN nodes 714 via an O1 interface.

In the example shown in FIG. 7, the intent framework functions (e.g., the intent management services configuration 730) is mostly deployed on the NRT RIC 708. In some embodiments, the intent policy functions may be managed with the rApp only. The configuration of FIG. 7 may be implemented based on a relevant functionality required to remain with the NRT RIC 708 for handling complex and less policy proximate functions. Such a configuration may handle complex intent translation and resolution due to the proximity to the rApp through the R1 interface, and may be useful in scenarios where an operator desires to have all the intent generation within the NRT RIC 708 (e.g., vendor specific).

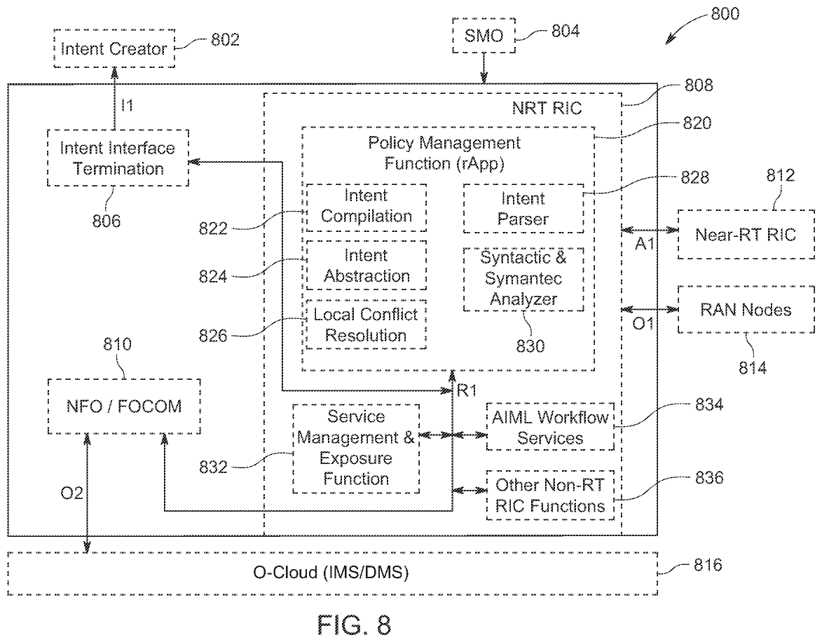

FIG. 8 is a diagram of an O-RAN framework 800, according to an embodiment. The O-RAN framework 800 may include an intent creator 802, an SMO framework 804, and intent interface termination 806 in communication with the intent creator 802 via an I1 interface, an NRT RIC 808, a NFO/FOCOM module 810, and an nRT RIC 812, RAN nodes 814 and an O-Cloud 816 (e.g., an IMS, a DMS, etc.). The NRT RIC 808 may include an rApp on which a policy management function module 820 is deployed. The NRT RIC 808 may include an intent compilation module 822, an intent abstraction module 824, an intent parser 828, a syntactic and semantic analyzer 830 and a local conflict resolution module 826 deployed on the rApp. The NRT RIC 808 may include a service management and exposure function module 832, an AIML workflow services module 834, and other NRT RIC functions 836. The policy management function module 820 may be in communication with the NFO/FOCOM module 810 via an R1 interface, the NFO/FOCOM module 810 may be in communication with the O-Cloud 816 via an O2 interface, the NRT RIC 808 may be in communication with the nRT RIC 812 via an A1 interface, and the NRT RIC 808 may be in communication with the RAN nodes 814 via an O1 interface.

As shown in FIG. 8, the intent framework may be deployed on the rApp with the policy management function module 820, such that every functionality of the intent framework communications over the R1 interface. The framework 800 may respond to intent policies more accurately in the case of errors or conflicts with previously injected intent policies, ongoing policies, and/or provisioned configuration changes over the R1 interface. The framework 800 may allow third-party intent frameworks to be integrated with the NRT RIC 808/SMO 804 through the R1 interface.

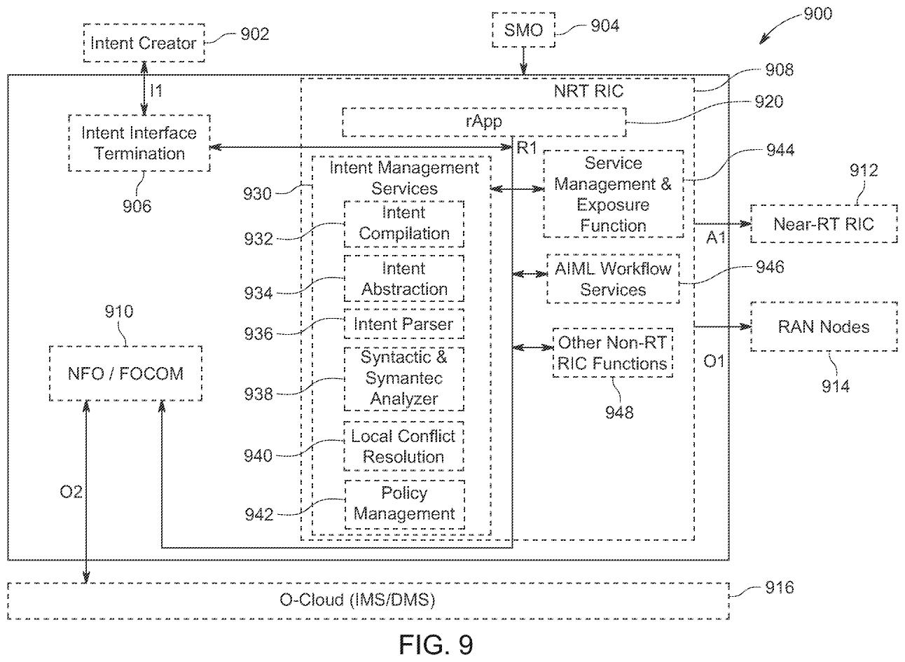

FIG. 9 is a diagram of an O-RAN framework 900, according to an embodiment. The O-RAN framework 900 may include an intent creator 902, an SMO framework 904, and intent interface termination 906 in communication with the intent creator 902 via an I1 interface, an NRT RIC 908, a NFO/FOCOM module 910, and an nRT RIC 912, RAN nodes 914 and an O-Cloud 916 (e.g., an IMS, a DMS, etc.). The NRT RIC 908 may include an rApp 920, an intent management services configuration 930 including an intent compilation module 932, an intent abstraction module 934, an intent parser 936, a syntactic and semantic analyzer 938 a local conflict resolution module 940, and a policy management function module 942. The NRT RIC 908 may include a service management and exposure function module 944, an AIML workflow services module 946, and other NRT RIC functions 948. The policy management function module 920 may be in communication with the NFO/FOCOM module 910 via an R1 interface, the NFO/FOCOM module 910 may be in communication with the O-Cloud 916 via an O2 interface, the NRT RIC 908 may be in communication with the nRT RIC 912 via an A1 interface, and the NRT RIC 908 may be in communication with the RAN nodes 914 via an O1 interface.

As shown in FIG. 9, the intent management functions may be deployed on the NRT RIC 908, including the policy management function module 942, as opposed to having the policy management function module 942 deployed on the rApp 920. Thus, intent policies may be processed as is described above with or without utilization of the R1 interface, relieving overall load of the R1 interface throughout the framework 900.

The system may utilize various factors to determine which framework to use of those described with respect to FIGS. 5-9. The system may consider types of intent policies to be handled. For example, the intent policies may be generated internally or externally. Furthermore, the intent creator may be outside of the SMO framework (e.g., an external intent policy), and such an intent may require frequent communication with the intent creator. In such a case, the system may determine to utilize framework 600. However, internal intent policies may be generated within the NRT RIC frameworks (e.g., the operator may push intent policies through the rApp), and as such, the system may determine to utilize frameworks 700, 800 and/or 900.

The system may consider targets for the intent policies. The targets may include RAN nodes, nRT RICs, O-Cloud and/or SMO/NRT RIC frameworks. When the intent policy targets RAN nodes, nRT RICs, O-Clouds, etc., the system may implement frameworks 600, 700 and/or 800 due to the involvement of the rApp through which the operator is provided more control over targeted elements. When the intent policy targets a management system, such at the SMO, NRT RIC, etc., then framework 900 may be deployed, as in framework 900, the reliability and availability of the system may be managed within the platform. For example, availability and reliability of the NFO/FOCOM may be very important and the intent creator may pass high level objectives (e.g. business level of abstraction). However, the platform may manage itself after receiving the intent policy to produce policies or configurations required to maintain availability and reliability of the system.

The system may determine an abstraction level or class of the intent policies as is described above. A business level intent policy may require framework to generate a policy from a primitive stage due to a lack of key indicators in the intent policy. Thus, the rApp may process this as a compiled intent and create policy/configurations using the AIML workflow services. A system level intent policy may include more detailed information, such as key indicators, target nodes, etc. Thus, the platform may host most of the intent framework functionality, and the rApp may optionally help derive actual configurations for the nodes.

O-RAN architecture defines the NRT RICE as SMO internal functionality. However, some operators may choose to have NRT RIC as a standalone solution (e.g., providing a private 5th generation (5G) network may have NFO/FOCOM from a cloud service provider due to a small network, however, such scenarios require the NRT RIC to manage RAN resources through the Non-RT RIC). In this scenario, most or all of the intent framework may be integrated with the NRT RIC platform, as shown in frameworks 700, 800 and 900.

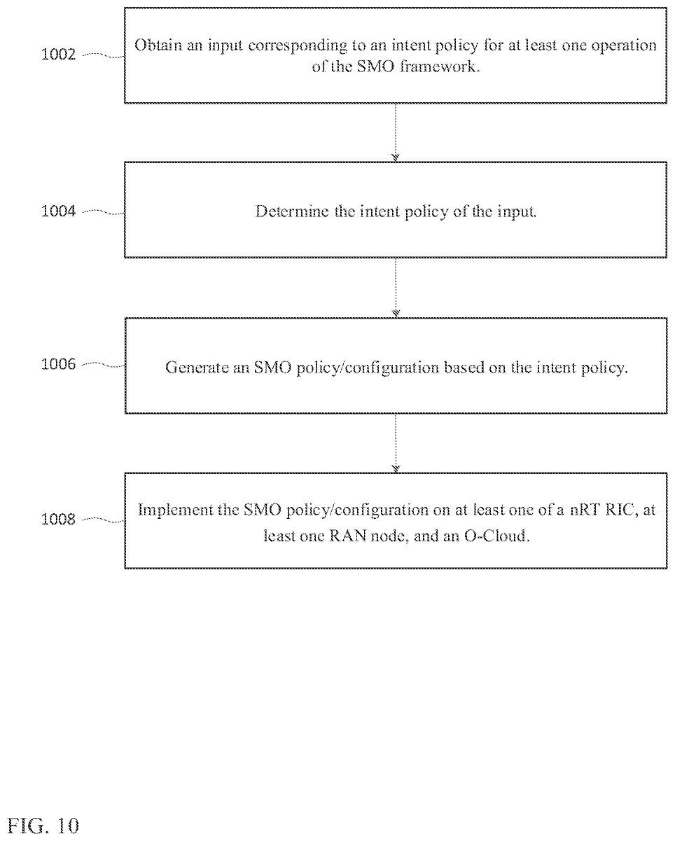

FIG. 10 is a flowchart of a method of generating policies/configurations in an O-RAN SMO framework, where the SMO framework may include an intent interface termination and an NRT RIC. In operation 1002, the system may obtain an input corresponding to an intent policy for at least one operation of the SMO framework. In operation 1004, the system may determine the intent policy of the input. In operation 1006, the system may generate an SMO policy/configuration based on the intent policy. In operation 1008, the system may implement the SMO policy/configuration on at least one of an nRT RIC, at least one RAN node, and an O-Cloud.

The system may determine an abstraction level of the intent policy, where the abstraction level includes one of a business abstraction level and a system abstraction level. The system may, based on determining the abstraction level of the intent policy as the business abstraction level, translate the intent policy to correspond to at least one system level command.

The system may obtain the input and determine the intent policy by the intent interface termination, and generate the SMO policy/configuration by the NRT RIC. The system may obtain the input by the intent interface termination, and determine the intent policy and generate the SMO policy/configuration by the NRT RIC. The NRT RIC may include an rApp on which a policy management function module is deployed, and the system may obtain the input by the intent interface termination, and determine the intent policy and generate the SMO policy/configuration by the policy management function module that is deployed on the rApp. The NRT RIC may include an rApp and a policy management function module deployed outside of the rApp, and the system may obtain the input by the intent interface termination, and determine the intent policy and generate the SMO policy/configuration by the policy management function module that is not deployed on the rApp.

The systems, methods, devices, etc., disclosed herein allow intent policies to be input from various users of varying types of language, such that SMO policies/configurations may be implemented based on the varying intent policies.

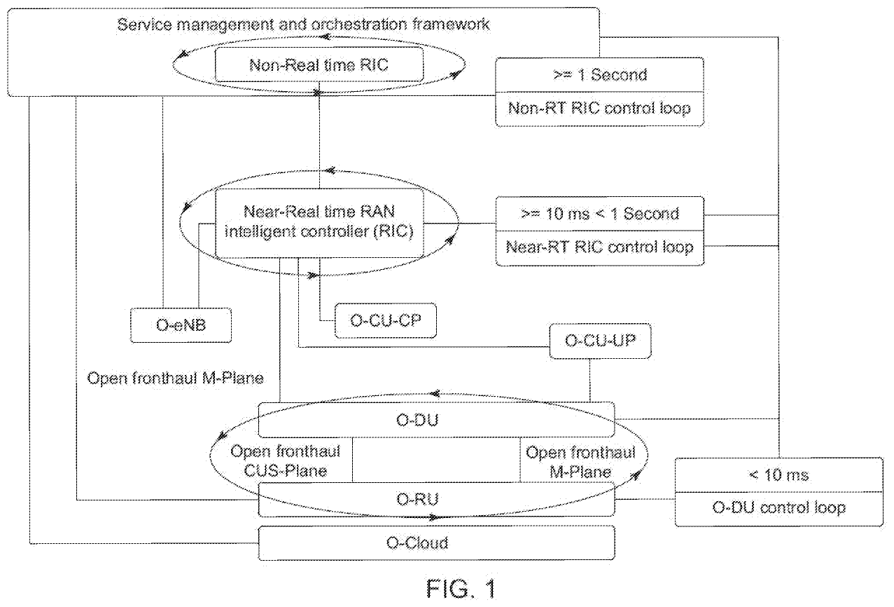

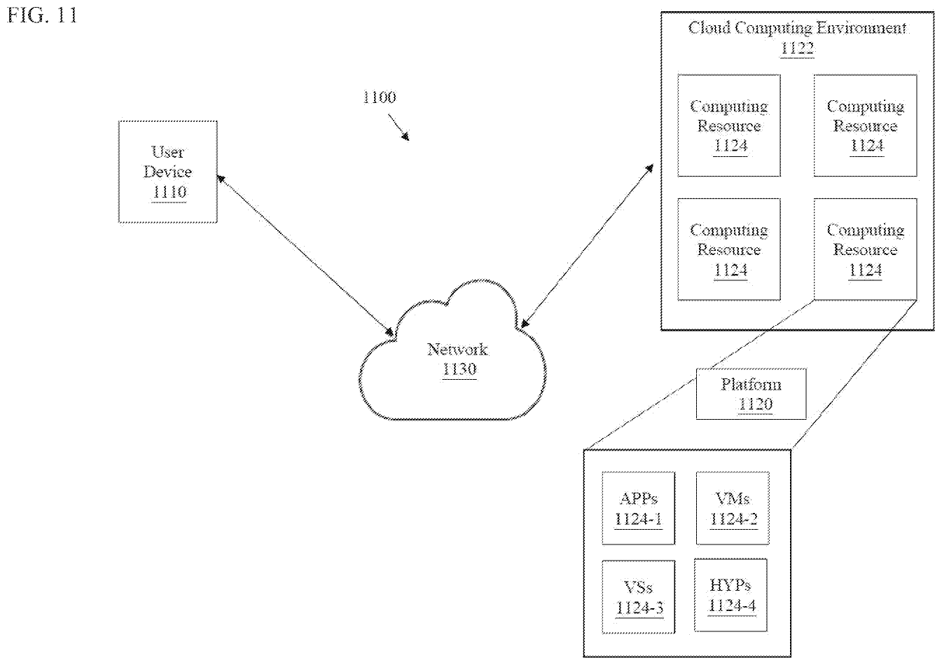

FIG. 11 is a diagram of an example environment 1100 in which systems and/or methods, described herein, may be implemented. As shown in FIG. 11, environment 1100 may include a user device 1110, a platform 1120, and a network 1130. Devices of environment 1100 may interconnect via wired connections, wireless connections, or a combination of wired and wireless connections. In embodiments, any of the functions and operations described with reference to FIG. 1 above may be performed by any combination of elements illustrated in FIG. 11.

User device 1110 includes one or more devices capable of receiving, generating, storing, processing, and/or providing information associated with platform 1120. For example, user device 1110 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, user device 1110 may receive information from and/or transmit information to platform 1120.

Platform 1120 includes one or more devices capable of receiving, generating, storing, processing, and/or providing information. In some implementations, platform 1120 may include a cloud server or a group of cloud servers. In some implementations, platform 1120 may be designed to be modular such that certain software components may be swapped in or out depending on a particular need. As such, platform 1120 may be easily and/or quickly reconfigured for different uses.

In some implementations, as shown, platform 1120 may be hosted in cloud computing environment 1122. Notably, while implementations described herein describe platform 1120 as being hosted in cloud computing environment 1122, in some implementations, platform 1120 may not be cloud-based (i.e., may be implemented outside of a cloud computing environment) or may be partially cloud-based.

Cloud computing environment 1122 includes an environment that hosts platform 1120. Cloud computing environment 1122 may provide computation, software, data access, storage, etc. services that do not require end-user (e.g., user device 1110) knowledge of a physical location and configuration of system(s) and/or device(s) that hosts platform 1120. As shown, cloud computing environment 1122 may include a group of computing resources 1124 (referred to collectively as “computing resources 1124” and individually as “computing resource 1124”).

Computing resource 1124 includes one or more personal computers, a cluster of computing devices, workstation computers, server devices, or other types of computation and/or communication devices. In some implementations, computing resource 1124 may host platform 1120. The cloud resources may include compute instances executing in computing resource 1124, storage devices provided in computing resource 1124, data transfer devices provided by computing resource 1124, etc. In some implementations, computing resource 1124 may communicate with other computing resources 1124 via wired connections, wireless connections, or a combination of wired and wireless connections.

As further shown in FIG. 11, computing resource 1124 includes a group of cloud resources, such as one or more applications (“APPs”) 1124-1, one or more virtual machines (“VMs”) 1124-2, virtualized storage (“VSs”) 1124-3, one or more hypervisors (“HYPs”) 1124-4, or the like.

Application 1124-1 includes one or more software applications that may be provided to or accessed by user device 1110. Application 1124-1 may eliminate a need to install and execute the software applications on user device 1110. For example, application 1124-1 may include software associated with platform 1120 and/or any other software capable of being provided via cloud computing environment 1122. In some implementations, one application 1124-1 may send/receive information to/from one or more other applications 1124-1, via virtual machine 1124-2.

Virtual machine 1124-2 includes a software implementation of a machine (e.g., a computer) that executes programs like a physical machine. Virtual machine 1124-2 may be either a system virtual machine or a process virtual machine, depending upon use and degree of correspondence to any real machine by virtual machine 1124-2. A system virtual machine may provide a complete system platform that supports execution of a complete operating system (“OS”). A process virtual machine may execute a single program, and may support a single process. In some implementations, virtual machine 1124-2 may execute on behalf of a user (e.g., user device 1110), and may manage infrastructure of cloud computing environment 1122, such as data management, synchronization, or long-duration data transfers.

Virtualized storage 1124-3 includes one or more storage systems and/or one or more devices that use virtualization techniques within the storage systems or devices of computing resource 1124. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 1124-4 may provide hardware virtualization techniques that allow multiple operating systems (e.g., “guest operating systems”) to execute concurrently on a host computer, such as computing resource 1124. Hypervisor 1124-4 may present a virtual operating platform to the guest operating systems, and may manage the execution of the guest operating systems. Multiple instances of a variety of operating systems may share virtualized hardware resources.

Network 1130 includes one or more wired and/or wireless networks. For example, network 1130 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 11 are provided as an example. In practice, there may be additional devices and/or networks, fewer devices and/or networks, different devices and/or networks, or differently arranged devices and/or networks than those shown in FIG. 11. Furthermore, two or more devices shown in FIG. 11 may be implemented within a single device, or a single device shown in FIG. 11 may be implemented as multiple, distributed devices. Additionally, or alternatively, a set of devices (e.g., one or more devices) of environment 1100 may perform one or more functions described as being performed by another set of devices of environment 1100.

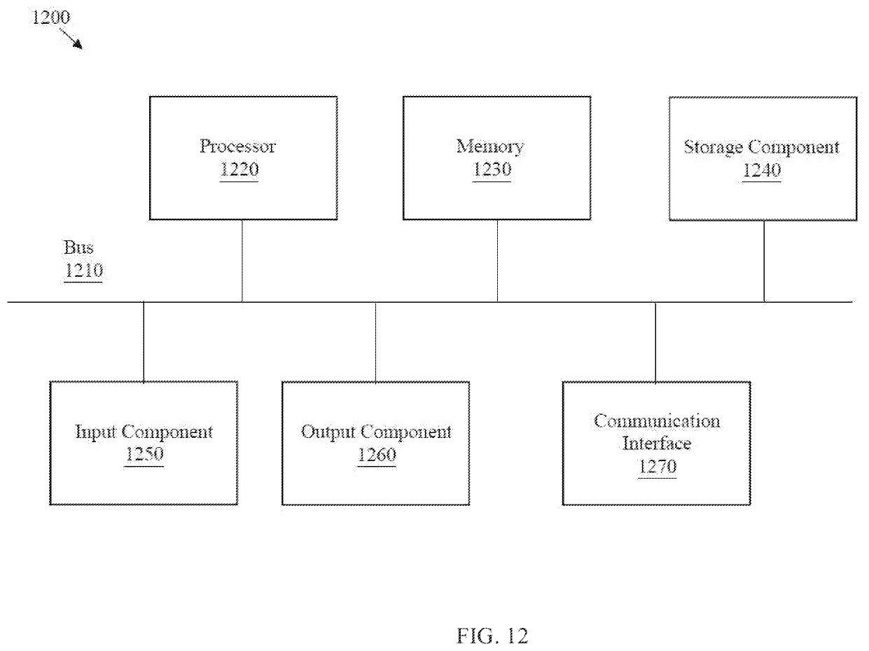

FIG. 12 is a diagram of example components of a device 1200. Device 1200 may correspond to user device 1110 and/or platform 1120. As shown in FIG. 12, device 1200 may include a bus 1210, a processor 1220, a memory 1230, a storage component 1240, an input component 1250, an output component 1260, and a communication interface 1270.

Bus 1210 includes a component that permits communication among the components of device 1200. Processor 1220 may be implemented in hardware, firmware, or a combination of hardware and software. Processor 1220 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 1220 includes one or more processors capable of being programmed to perform a function. Memory 1230 includes a random access memory (RAM), a read only memory (ROM), and/or another type of dynamic or static storage device (e.g., a flash memory, a magnetic memory, and/or an optical memory) that stores information and/or instructions for use by processor 1220.

Storage component 1240 stores information and/or software related to the operation and use of device 1200. For example, storage component 1240 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive. Input component 1250 includes a component that permits device 1200 to receive information, such as via user input (e.g., a touch screen display, a keyboard, a keypad, a mouse, a button, a switch, and/or a microphone). Additionally, or alternatively, input component 1250 may include a sensor for sensing information (e.g., a global positioning system (GPS) component, an accelerometer, a gyroscope, and/or an actuator). Output component 1260 includes a component that provides output information from device 1200 (e.g., a display, a speaker, and/or one or more light-emitting diodes (LEDs)).

Communication interface 1270 includes a transceiver-like component (e.g., a transceiver and/or a separate receiver and transmitter) that enables device 1200 to communicate with other devices, such as via a wired connection, a wireless connection, or a combination of wired and wireless connections. Communication interface 1270 may permit device 1200 to receive information from another device and/or provide information to another device. For example, communication interface 1270 may include an Ethernet interface, an optical interface, a coaxial interface, an infrared interface, a radio frequency (RF) interface, a universal serial bus (USB) interface, a Wi-Fi interface, a cellular network interface, or the like.

Device 1200 may perform one or more processes described herein. Device 1200 may perform these processes in response to processor 1220 executing software instructions stored by a non-transitory computer-readable medium, such as memory 1230 and/or storage component 1240. A computer-readable medium is defined herein as a non-transitory memory device. A memory device includes memory space within a single physical storage device or memory space spread across multiple physical storage devices.

Software instructions may be read into memory 1230 and/or storage component 1240 from another computer-readable medium or from another device via communication interface 1270. When executed, software instructions stored in memory 1230 and/or storage component 1240 may cause processor 1220 to perform one or more processes described herein.

Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 12 are provided as an example. In practice, device 1200 may include additional components, fewer components, different components, or differently arranged components than those shown in FIG. 12. Additionally, or alternatively, a set of components (e.g., one or more components) of device 1200 may perform one or more functions described as being performed by another set of components of device 1200.

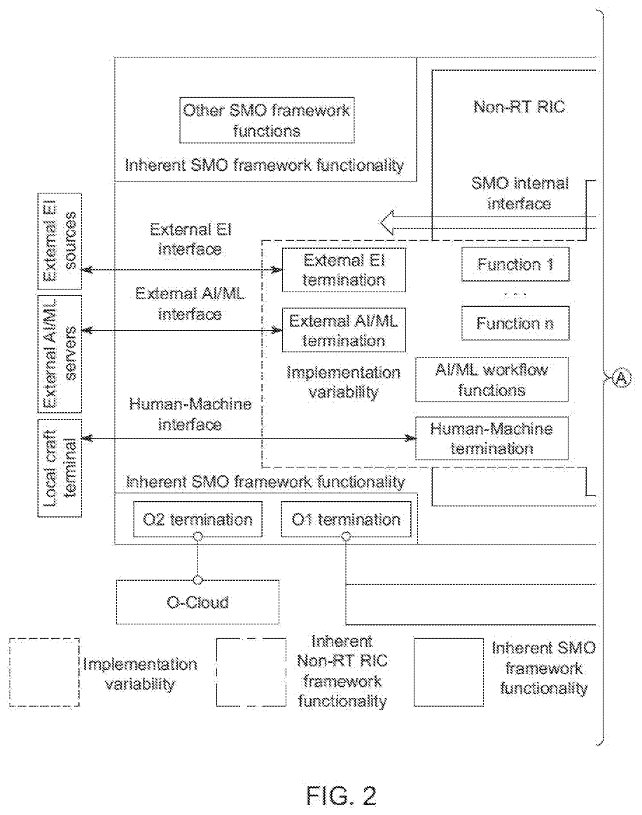

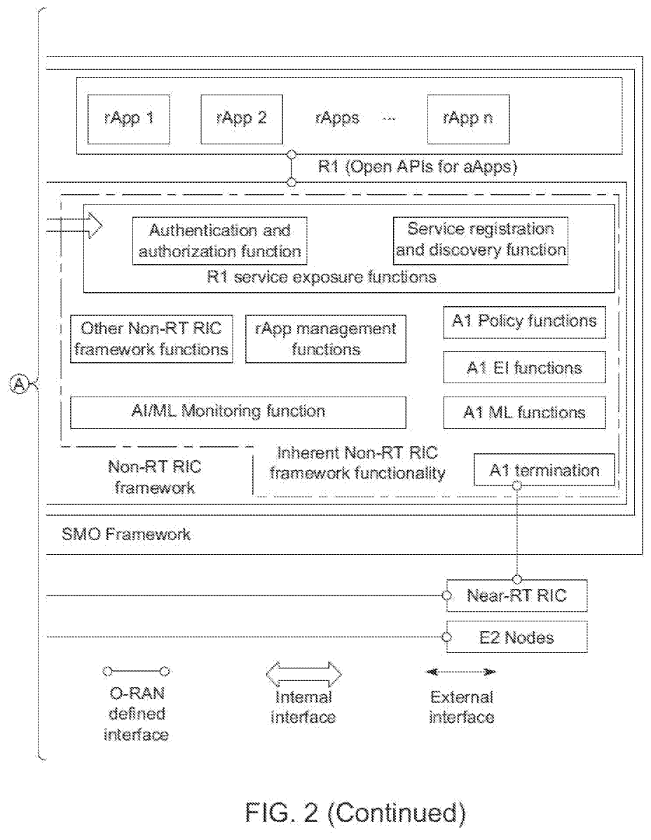

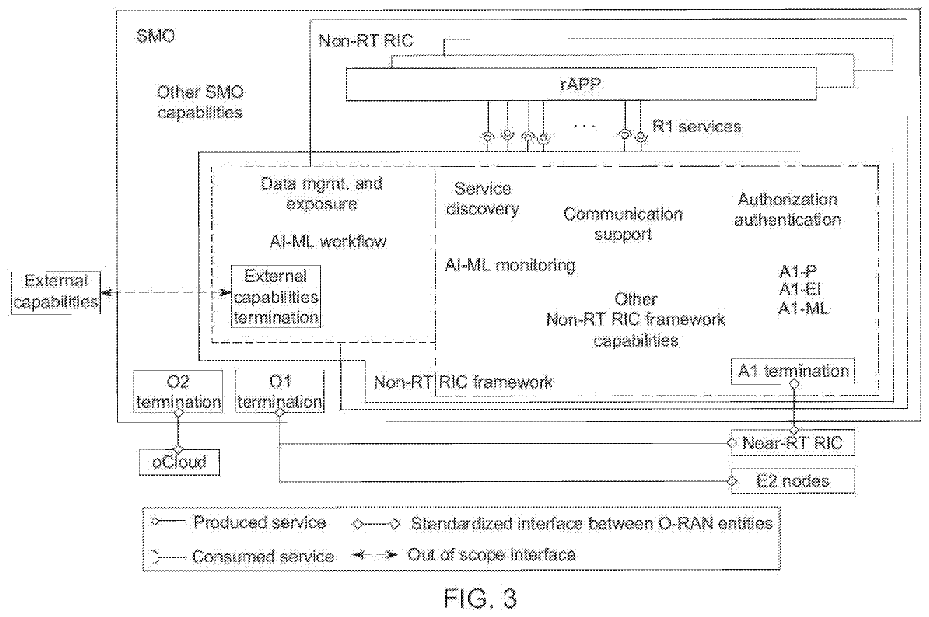

In embodiments, any one of the operations or processes of FIGS. 1-10 may be implemented by or using any one of the elements illustrated in FIGS. 11 and 12.

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

What is claimed is:

1. A method of generating policies/configurations in an open radio access network (O-RAN) service management and orchestration (SMO) framework, the SMO framework comprising an intent interface termination and a non-real-time RAN intelligent controller (NRT RIC), the method comprising:
obtaining an input corresponding to an intent policy for at least one operation of the SMO framework;
determining the intent policy of the input;
generating an SMO policy/configuration based on the intent policy; and
implementing the SMO policy/configuration on at least one of a near-real-time RIC (nRT RIC), at least one RAN node, and an O-RAN Cloud (O-Cloud).

2. The method of claim 1, further comprising determining an abstraction level of the intent policy,
wherein the abstraction level comprises one of a business abstraction level and a system abstraction level.

3. The method of claim 2, further comprising, based on determining the abstraction level of the intent policy as the business abstraction level, translating the intent policy to correspond to at least one system level command.

4. The method of claim 1, wherein the obtaining of the input and the determining of the intent policy are performed by the intent interface termination, and
wherein the generating of the SMO policy/configuration is performed by the NRT RIC.

5. The method of claim 1, wherein the obtaining of the input is performed by the intent interface termination, and
wherein the determining of the intent policy and the generating of the SMO policy/configuration are performed by the NRT RIC.

6. The method of claim 1, wherein the NRT RIC comprises an rApp on which a policy management function module is deployed,
wherein the obtaining of the input is performed by the intent interface termination, and wherein the determining of the intent policy and the generating of the SMO policy/configuration is performed by the policy management function module.

7. The method of claim 1, wherein the NRT RIC comprises an rApp and a policy management function module deployed outside of the rApp,
wherein the obtaining of the input is performed by the intent interface termination, and
wherein the determining of the intent policy and the generating of the SMO policy/configuration is performed by the policy management function module.

8. A system for generating policies/configurations in an open radio access network (O-RAN) service management and orchestration (SMO) framework, the SMO framework comprising an intent interface termination and a non-real-time RAN intelligent controller (NRT RIC), the system comprising:
at least one memory storing instructions; and
at least one processor configured to execute the instructions to:
obtain an input corresponding to an intent policy for at least one operation of the SMO framework;
determine the intent policy of the input;
generate an SMO policy/configuration based on the intent policy; and
implement the SMO policy/configuration on at least one of a near-real-time RIC (nRT RIC), at least one RAN node, and an O-RAN Cloud (O-Cloud).

9. The system of claim 8, wherein the at least one processor is further configured to execute the instructions to determine an abstraction level of the intent policy, and
wherein the abstraction level comprises one of a business abstraction level and a system abstraction level.

10. The system of claim 9, wherein the at least one processor is further configured to, based on determining the abstraction level of the intent policy as the business abstraction level, translate the intent policy to correspond to at least one system level command.

11. The system of claim 8, wherein the at least one processor is configured to execute the instructions to obtain the input and determine of the intent policy by the intent interface termination, and
wherein the at least one processor is configured to execute the instructions to generate the SMO policy/configuration by the NRT RIC.

12. The system of claim 8, wherein the at least one processor is configured to execute the instructions to obtain the input by the intent interface termination, and
wherein the at least one processor is configured to execute the instructions to determine the intent policy and generate the SMO policy/configuration by the NRT RIC.

13. The system of claim 8, wherein the NRT RIC comprises an rApp on which a policy management function module is deployed,
wherein the at least one processor is configured to execute the instructions to obtain the input by the intent interface termination, and
wherein the at least one processor is configured to execute the instructions to determine the intent policy and generate the SMO policy/configuration by the policy management function module.

14. The system of claim 8, wherein the NRT RIC comprises an rApp and a policy management function module deployed outside of the rApp,
wherein the at least one processor is configured to execute the instructions to obtain the input by the intent interface termination, and
wherein the at least one processor is configured to execute the instructions to determine the intent policy and generate the SMO policy/configuration by the policy management function module.

15. A non-transitory computer-readable storage medium storing instructions that, when executed by at least one processor in an open radio access network (O-RAN) service management and orchestration (SMO) framework, cause the at least one processor to:
obtain an input corresponding to an intent policy for at least one operation of the SMO framework;
determine the intent policy of the input;
generate an SMO policy/configuration based on the intent policy; and
implement the SMO policy/configuration on at least one of a near-real-time RAN intelligent controller (nRT RIC), at least one RAN node, and an O-RAN Cloud (O-Cloud).

16. The storage medium of claim 15, wherein the instructions, when executed, further cause the at least one processor to determine an abstraction level of the intent policy, and
wherein the abstraction level comprises one of a business abstraction level and a system abstraction level.

17. The storage medium of claim 16, wherein the instructions, when executed, further cause the at least one processor to, based on determining the abstraction level of the intent policy as the business abstraction level, translate the intent policy to correspond to at least one system level command.

18. The storage medium of claim 15, wherein the SMO framework comprises an intent interface termination and a non-real-time RAN RIC (NRT RIC),
wherein the instructions, when executed, further cause the at least one processor to obtain the input and determine of the intent policy by the intent interface termination, and
wherein the instructions, when executed, further cause the at least one processor to generate the SMO policy/configuration by the NRT RIC.

19. The storage medium of claim 15, wherein the SMO framework comprises an intent interface termination and a non-real-time RAN RIC (NRT RIC),
wherein the instructions, when executed, further cause the at least one processor to obtain the input by the intent interface termination, and
wherein the instructions, when executed, further cause the at least one processor to determine the intent policy and generate the SMO policy/configuration by the NRT RIC.

20. The storage medium of claim 15, wherein the SMO framework comprises an intent interface termination and a non-real-time RAN RIC (NRT RIC),
wherein the NRT RIC comprises an rApp on which a policy management function module is deployed,
wherein the instructions, when executed, further cause the at least one processor to obtain the input by the intent interface termination, and
wherein the instructions, when executed, further cause the at least one processor to determine the intent policy and generate the SMO policy/configuration by the policy management function module.
